(19) United States
(12) Patent Application Publication
(10) Pub. No.: US 2010/0293074 A1
(43) Pub. Date: Nov. 18, 2010

(54) SYSTEM AND METHOD FOR TRACKING FILTER ACTIVITY AND MONITORING TRENDS ASSOCIATED WITH SAID ACTIVITY

(75) Inventor: Daniel F. SCHMIDT, San Francisco, CA (US)

Correspondence Address: NIXON PEABODY, LLP, 401 9TH STREET, NW, SUITE 900, WASHINGTON, DC, 20004-2128, US

(73) Assignee: CBS INTERACTIVE, INC., County of New Castle, DE (US)

(21) Appl. No.: 12/467,394

(22) Filed: May 18, 2009

(51) Int. Cl. G06Q 30/00; G06F 17/30; G06T 11/20; G06F 3/048; G06Q 50/00

(52) U.S. Cl. 705/27; 345/440.2; 715/808

(57) ABSTRACT

Various embodiments are presented which comprise an electronic catalog of products, wherein the catalog comprises a taxonomy of product categories and products within the categories, wherein various users input filter parameters and these are monitored, whereupon the monitored data is manipulated and analyzed and presented to the user to help the user appreciate trends in the filter data.

### CROSS-REFERENCE TO RELATED APPLICATION

The present invention shares common subject matter with the following applications, which also share common inventor and assignee: “SYSTEM AND METHOD FOR TARGETING CONTENT BASED ON FILTER ACTIVITY”, “SYSTEM AND METHOD FOR PRESENTING FILTER OPTIONS TO A USER BASED ON ONGOING MONITORING OF FILTER SELECTIONS”, and “SYSTEM AND METHOD FOR INCORPORATING USER INPUT INTO FILTER-BASED NAVIGATION OF AN ELECTRONIC CATALOG”, all also submitted on this date. These co-pending applications were not previously published in any form.

### FIELD OF THE INVENTION

The present invention relates to a system and method for providing information to the user of an online catalog about patterns in filter parameter selections based on the filter parameters that a group of previous users specified while navigating the catalog.

### DESCRIPTION OF THE RELATED ART

Many websites are configured as online catalogs. These catalogs act as alternatives to traditional paper catalogs and offer enhanced navigational features when compared to their paper counterparts, as well as the advantages of broad, easy distribution. With the advent and increasing popularity of the Internet, suppliers have access to a much larger customer base. Through the Internet, the market base of manufacturers and resellers may be maximized while the associated overhead may potentially be drastically reduced. If an electronic catalog is well-organized and presented, it can help consumers to make good purchasing decisions by providing extensive information about the products they contain in an easy-to-navigate manner. Such a catalog either allows the consumers to gain information about products they will purchase elsewhere or to make purchases within the site itself. Additionally, such a catalog serves as a site where companies may purchase advertising to market their products.

Such electronic catalogs generally store, in a database, information about a number of products which may be anything from electronics to housewares to apparel, or any other type of item which may be depicted and/or described electronically. Such items may be described by a taxonomy, which describes the set of products with a set of information that consists of a set of attributes that assume values. That is, each product might be associated with a price, brand, or other attribute. Some attributes would only be stored for some classes of product. For example, weight might be a attribute with respect to laptops, but not desktop computers, while both might have a processor speed attribute.

Once a retailer or other content provider has provided a taxonomy for its products, it remains for the users of the catalog system to retrieve the products using the taxonomy system. One way to do this is by performing searches using filters. These filters are composed of individual filter parameters, which are rules which narrow the selection of products in a taxonomy according to some criterion. Such filters constrain the allowable values of the attributes, and thereby generate a more manageable subset of the products that the user may use, manipulate, and digest. Together, a set of filter parameters forms a filter parameter set, which represents a progressively narrowed selection of filter parameters. An example filter parameter set would be that if a user were searching for digital cameras, the user might want cameras from Canon™, which are 6 megapixels or greater, and which are under $300 in price. A filter parameter set further consists of the individual, discrete filter parameters, which limit the user's search in a progressive manner. Each filter parameter imposes a constraint on one or more product attributes at a time.

Filters allow the users to reduce the potentially huge numbers of products which otherwise occupy catalogs and reduce them to a manageable numbers. They also allow users to focus their searches to meet their individualized needs, as well as incorporating factors such as ability to pay or brand requirements due to purchasing contracts.

### SUMMARY OF THE INVENTION

The amassed filter data provide valuable insights through analysis and visualizations. By performing mathematical and statistical transformations upon the amassed filter data, grouped data sets are available that can be turned into visualizations such as line graphs, bar graphs, histograms, and other visual representations that represent how the number of selections of various filter parameter selections changes over time. Moreover, visual representations of other aspects of the parameters, such as pie charts which represent proportions of filter parameter selections can provide valuable information to the user.

Embodiments which present valuable available information to the user by presenting information about filter selection trends meet many unmet needs and offer many unexpected advantages. Such embodiments serve the need of understanding trends in buying preferences as well as interest in products in electronic catalogs. First, no known products or services mine filter parameter selection data in the manner provided for by these embodiments and offer such useful information about the catalog. Second, by incorporating information known about the users, as well as the order in which they make their selections into an analysis of filter selections, higher-level inferences are possible which can potentially add richer levels of meaning which can be depicted visually. Third, the visual approach adopted in some of these embodiments complements the Web-based or GUI interface which is preferably used to access the catalog. Fourth, the embodiments facilitate careful control and inspection of given time periods to determine how trends in filter parameter selection change over time and focus on specific time intervals. Fifth, the embodiments allow users to isolate specific values associates with filter attributes under consideration so as to obtain more detailed information about how filter activity has changed over time. Thus, the embodiments presents the user with a variety of tools which help mine value from monitoring the stream of filter selections which occurs as a natural part of operating an electronic catalog based on a taxonomy.

The information provided by the filter selections can provide useful and unique insights into user's priorities and interests in using the catalog. At a superficial level, of course, it indicates what users are searching for. However, that information can be used for marketing, to improve the design of the system, to provide suggestions to the users, to improve various aspects or to improve parts of the system interface.

According to one embodiment of the invention, there is provided: A computer system designed to provide filter parameter trend information, comprising: a database module configured to store an electronic catalog of products, wherein the catalog comprises a taxonomy of products categories and products within the categories, the catalog further comprising attributes which describe products in a category and at least one value for said attributes, a user interface module configured to accept filter parameters, where each filter parameter specifies at least one of a product category and an attribute, in response to a selection by at least one user, a query module configured to receive the filter parameters, query the catalog, and present a subset of products in the catalog corresponding to the filter parameters to said user interface module for display to said at least one user, a monitoring module configured to track the received filter parameters and generates a set of user activity data that indicates the filter parameters selected by said at least one user, and a user activity data output module configured to, in response to a user selection of at least one filter parameter, provide user activity data output related to said user activity data related to previous users selecting filter parameters that are the same or similar to the user's selection.

According to one embodiment of the invention, there is provided. A method involving steps to be performing on a computing system consisting of multiple modules designed to perform computing functions which transform data monitoring results, wherein at least part of the computing system's functionality is performed by hardware, comprising: using a computer processor, operating a database module configured to store an electronic catalog of products, wherein the catalog comprises a taxonomy of products categories and products within the categories, the catalog further comprising attributes which describe products in a category and at least one value for said attributes, using a computer processor, operating a user interface module configured to accept filter parameters, where each filter parameter specifies at least one of a product category and an attribute, in response to a selection by at least one user, using a computer processor, operating a query module configured to receive the filter parameters, query the catalog, and present a subset of products in the catalog corresponding to the filter parameters to said user interface module for display to said at least one user, using a computer processor, operating a monitoring module configured to track the received filter parameters and generates a set of user activity data that indicates the filter parameters selected by said at least one user, and using a computer processor, operating a user activity data output module configured to, in response to a user selection of at least one filter parameter, provide user activity data output related to said user activity data related to previous users selecting filter parameters that are the same or similar to the user's selection.

According to one embodiment of the invention, there is provided: An apparatus involving means for performing steps to be performed on a computing system consisting of multiple modules designed to perform computing functions, wherein at least part of the computing system's functionality is performed by hardware for facilitating browsing of catalog information, the apparatus comprising: means for, using a computer processor, operating a database module configured to store an electronic catalog of products, wherein the catalog comprises a taxonomy of products categories and products within the categories, the catalog further comprising attributes which describe products in a category and at least one value for said attributes, means for, using a computer processor, operating a user interface module configured to accept filter parameters, where each filter parameter specifies at least one of a product category and an attribute, in response to a selection by at least one user, means for, using a computer processor, operating a query module configured to receive the filter parameters, query the catalog, and present a subset of products in the catalog corresponding to the filter parameters to said user interface module for display to said at least one user, means for, using a computer processor, operating a monitoring module configured to track the received filter parameters and generates a set of user activity data that indicates the filter parameters selected by said at least one user; and means for, using a computer processor, operating a user activity data output module configured to, in response to a user selection of at least one filter parameter, provide user activity data output related to said user activity data related to previous users selecting filter parameters that are the same or similar to the user's selection.

According to one embodiment of the invention, there is provided: Computer readable media, having instructions stored thereon, wherein the instructions, when executed by a computer processor, perform steps to be performed on a computing system consisting of multiple modules designed to perform computing functions, wherein at least part of the computing system's functionality is performed by hardware for facilitating browsing of catalog information, the instructions comprising: instructions for operating a database module configured to store an electronic catalog of products, wherein the catalog comprises a taxonomy of products categories and products within the categories, the catalog further comprising attributes which describe products in a category and at least one value for said attributes, instructions for operating a user interface module configured to accept filter parameters, where each filter parameter specifies at least one of a product category and an attribute, in response to a selection by at least one user, instructions for operating a query module configured to receive the filter parameters, query the catalog, and present a subset of products in the catalog corresponding to the filter parameters to said user interface module for display to said at least one user, instructions for operating a monitoring module configured to track the received filter parameters and generates a set of user activity data that indicates the filter parameters selected by said at least one user, and instructions for operating a user activity data output module configured to, in response to a user selection of at least one filter parameter, provide user activity data output related to said user activity data related to previous users selecting filter parameters that are the same or similar to the user's selection.

### BRIEF DESCRIPTION OF THE DRAWINGS

FIG. 1 is a diagram illustrating the interactions between the components of a system embodiment of the present invention.

FIG. 2 is a diagram illustrating a taxonomy in accordance with system in which the present invention may be implemented.

FIG. 3 is a screenshot of an catalog in accordance with the invention depicting a front-page for category selection.

FIG. 4 is a screenshot of an catalog in accordance with the invention depicting a page where the cell phone category has been selected.

FIG. 5 is a screenshot of an catalog in accordance with the invention depicting a page where AT&T™ cell phones have been selected.

FIG. 6 is a screenshot of an. catalog in accordance with the invention depicting a AT&T™ cell phones selling for between $50-$100 have been selected.

FIG. 7 is a screenshot of an catalog in accordance depicting a AT&T™ cell phones selling for between $50-$100 made by Sony Ericsson™ have been selected.

FIG. 8 is a flowchart illustrating the method according to one embodiment of the invention.

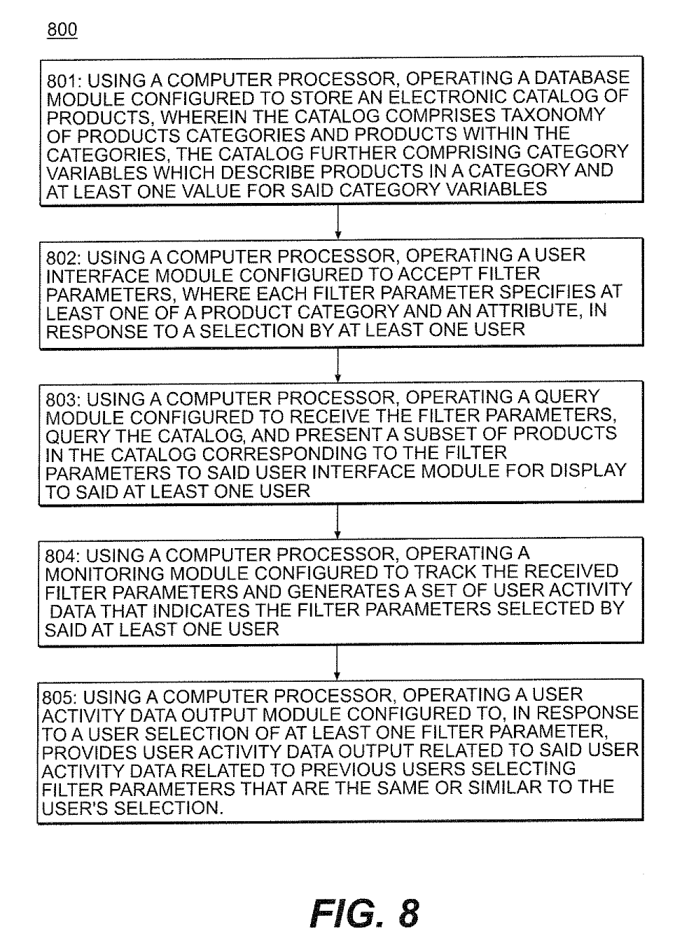

FIG. 9 is a mock display of recorded filter parameter logs and conclusions reached by an embodiment.

FIG. 10 is a sample set of line graphs produced by an embodiment.

FIG. 11 is a sample set of line graphs produced by an embodiment contained in a pop-up window set above a view of a list of products from the catalog of the embodiment.

### DETAILED DESCRIPTION OF THE INVENTION

In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

Embodiments are described herein that involve catalog data to which is stored and organized in an efficient manner through the use of a taxonomy. The taxonomy categorizes the products by using attributes, where products are associated with one or more values of the attributes. Such attributes describe and organize the products in the catalog for retrieval.

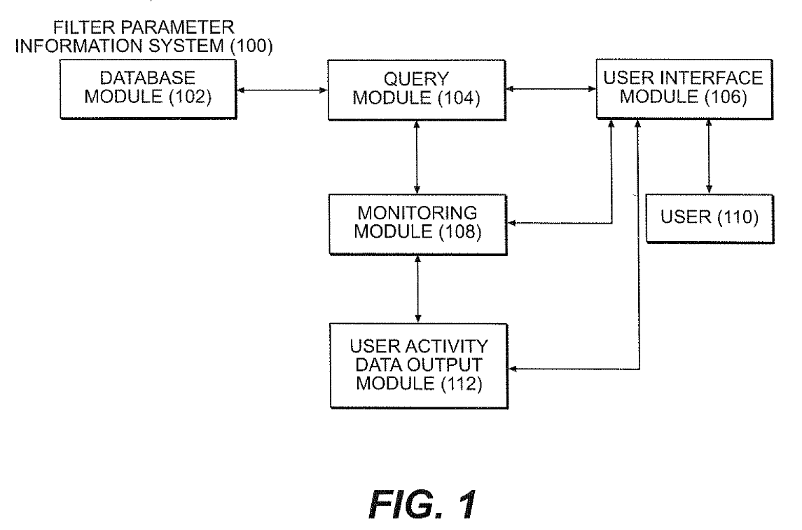

The configuration of the filter parameter information system 100 is characterized in FIG. 1. The catalog is ideally stored in a database module 102. The database may preferably employ a relational model, though it may alternatively employ a flat model, hierarchical model, network model, dimensional model, object model, object-relational model or any combination of the above or other database formats. The database may use a querying language such as SQL to retrieve data internally. Alternatively, the catalog may be stored in another file or collection of files such as a word processing document, or spreadsheet. The catalog information may be stored on a single machine or on multiple machines over a network. Ideally the catalog is accessible over the Web though a web browser or over another network, but embodiments exist where the catalog is accessible directly from a dedicated program where the catalog is stored locally. The contents of the catalog may be stored upon any tangible medium, such as, but not limited to: magnetic media, optical media, magneto-optical media, solid-state memory, and/or flash memory. The catalog may be stored locally or distributed over a network.

The database receives requests to access the contents of the catalog from query module 104, which mediates requests which are required by the user interface module 106, which may preferably be a monitor with input devices such as a keyboard and mouse providing a Web page, or other GUI interface, but may also involve alterative forms of interaction such as a command line, audio input/output or printed output, or assorted I/O peripherals such as a joystick, gamepad, trackpad, trackball, or other forms of I/O such as those used by the disabled, in order to interact with the users 110 and inform them about the operation of the system and obtain their desired filter parameters. This information flows to and from the user interface module 106 to the module module 108 and user activity data output module 112, where the computation performed by the device with respect to the information in the catalog. The user activity data output module 112 then presents the results of its computation to the users 110 via the user interface module 106.

Within the catalog, the taxonomy allows the products to be divided into categories, each of which may have subcategories each of which may have their own particular set of subcategories. This categorization exists based on the structure of the attributes that are each associated with a given category of product. As an example, in one embodiment, the products could be computers, which are divided into subcategories of laptops and desktops. The laptops can be further subdivided into subcategories, which might include “netbook”, “thin-and-light”, “mainstream”, and “desktop replacement”. Attributes in these subcategories can be weight, price (which might be divided by ranges), and type of processor. On the other hand the desktops might also be have the attributes of price and type of processor, but might have other attributes associated with them, like “form factor” and “number of drive bays”. Moreover, certain attributes might have multi-leveled answers. For example, a processor might be have a processor brand of Intel™, which would then lead to an attribute to differentiate that it was a “Core 2™”, then “Core 2 DUO™” as opposed to “Core 2 Quad™”.

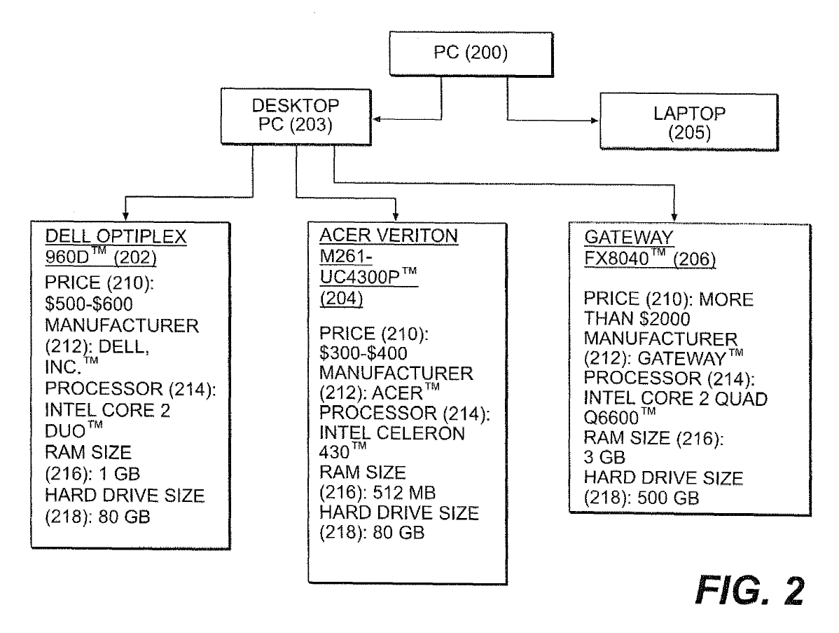

An example taxonomy is presented in FIG. 2, for Desktop PCs. The category of PCs 200 branches into the subcategories of Desktop PCs 203 and Laptop PCs 205. Desktop PCs 203 contain 3 examples of Desktop PCs, Dell Optiplex 960D™ (202) Acer Veriton M261-UC4300P™ (204), and the Gateway FX8040™ (206). Each of these has a value for attributes such as price 210, manufacturer 212, processor 214, RAM size 216, and hard drive size 218. Clearly, the implementation of such a taxonomy will differ by the database model or alternative schema used to store the database in the database module 102. However, given a relational model, such a taxonomy can be stored in one embodiment by associating the products with unique product IDs, then creating tables that associate the IDs with attributes, then creating tables that associate the IDs within the attributes with various values within the taxonomy, in a manner well known in the art to associate pieces of data with information that describes them through relational tables. However. many alternative embodiments are possible and this merely represents a preferred method of storing the catalog if the RDBMS approach is chosen.

It is to be noted that the catalog need not represent a set of tangible products represented by nodes within the taxonomy. The catalog may also operate on a digital level, and contain items of digital content. These items may contain digital text, audio, MIDI data, recorded audiobooks, digital music, bitmapped and/or vector graphics, digital photographs, video, movies, TV episodes, digital documents, animations, software, web content, multimedia, any form of encoded or archived data, and/or any other type of file or group of files which may be use to store useful computer data. These files may be stored locally or remotely from the web site or other interface shell which is used to allow the user to access the catalog.

Ideally, a catalog which is an embodiment of the invention which incorporates one or more of these data types will operate as described below, except that attributes of the one or more data types will reflect characteristics of the type of data involved when using filters instead of characteristics of merchandise. For example, a catalog which contains video might have attributes such as “length” (which might be various ranges of minutes), “type” (which might be “black-and-white” or “color”, or alternatively might include different levels of color quality), or might involve more qualitative attributes such as “genre” (i.e. action, comedy, drama, science-fiction, western) or “rating” (i.e., some sort of scale such as a star system or a points system). Note that some catalogs will have items in the taxonomy which may reflect pieces of merchandise which are linked to “virtual merchandise”, that is pieces of digital media . . . for example, pieces of digital music might be linked to real-world CD albums on which the songs are located. This may allow the embodiments to make intelligent ad recommendations . . . for example, if the filter selections (as described below) frequently involve songs from a specific artist, as well as albums that are inexpensive, if the user selects an album or a song from that artist, the embodiment may suggest advertising to the user find inexpensive digital media from that artist that the user would be likely to purchase.

Building upon the catalog, the embodiments allow the products to be accessed through the use of filters. These filters consist of combinations of filter parameters which limit the values. These filter parameters include a set of parameters requiring one or more of a given attribute equals a specific value; a given attribute is not equal to a specific value; a given attribute is greater than a specific value; a given attribute is greater than or equal to a specific value; a given attribute is less than a specific value; a given category value is less than or equal to a specific value; a given attribute falls within a specific interval; a given category value falls outside of a specific interval, or other restrictions on the variables.

The order in which filter parameters are selected may be significant, because, for example, if the user selects cameras such that they are 10 MP or greater as his or her first constraint, this may lead to available lens types that would not have been available had, for example, the user selected a camera that is $50 or less. Also, some heuristics used by certain embodiments may give weight to the first filters and assume that they are more important to the user.

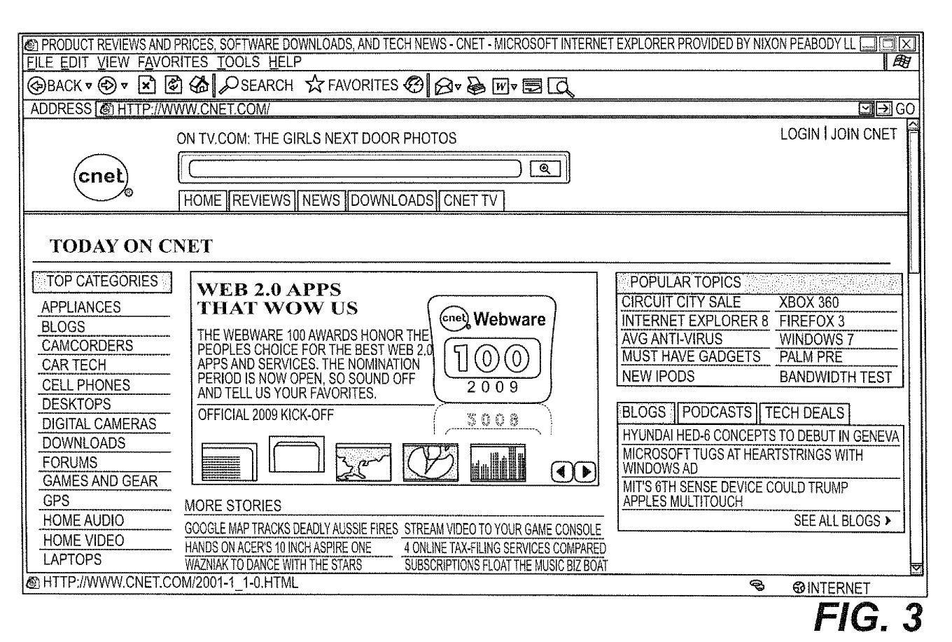

Screenshots illustrating an example of a catalog interface which would contain an assortment of technology products and then progressively use filter parameters to narrow the selection of products which are under consideration and which are displayed in FIGS. 3-7. Furthermore, the embodiments record and monitor one or more users' choice of filters over time, providing a pool of data which can then been used as a basis, in combination with a new filter selection, for recommendations of content.

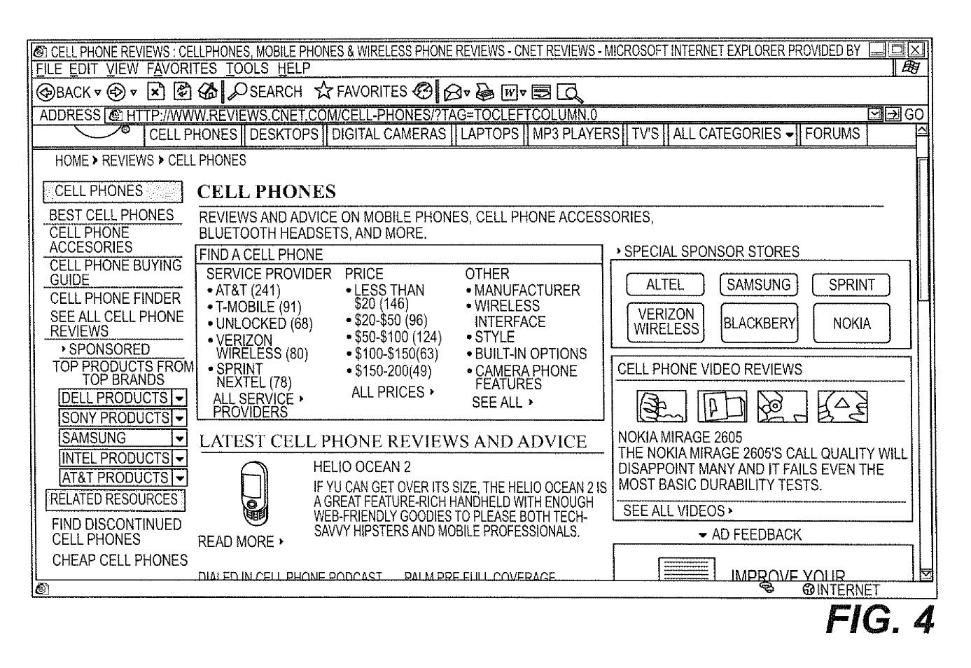

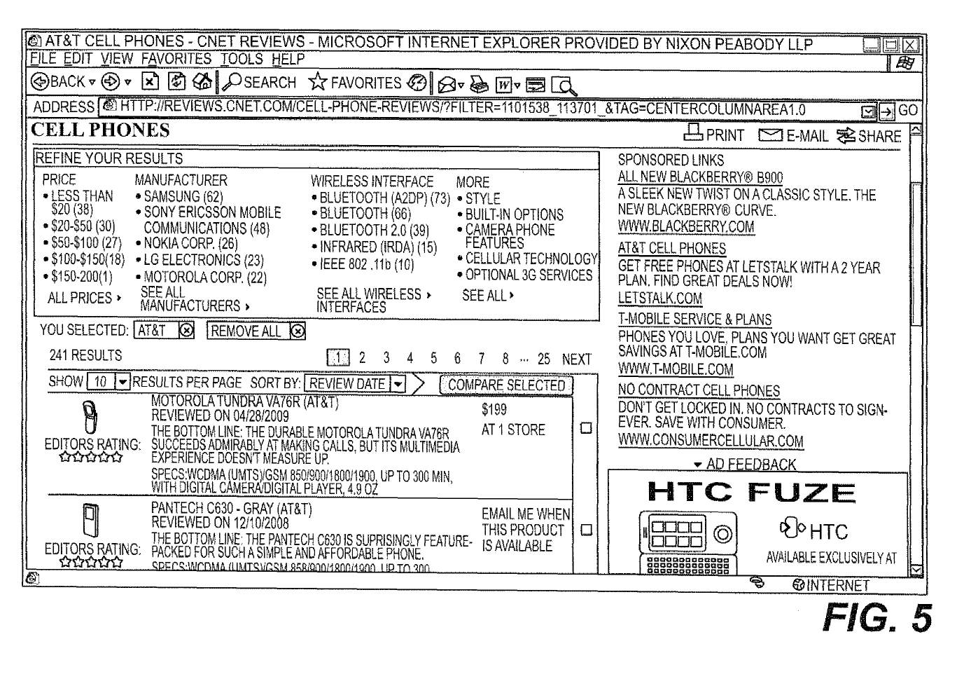

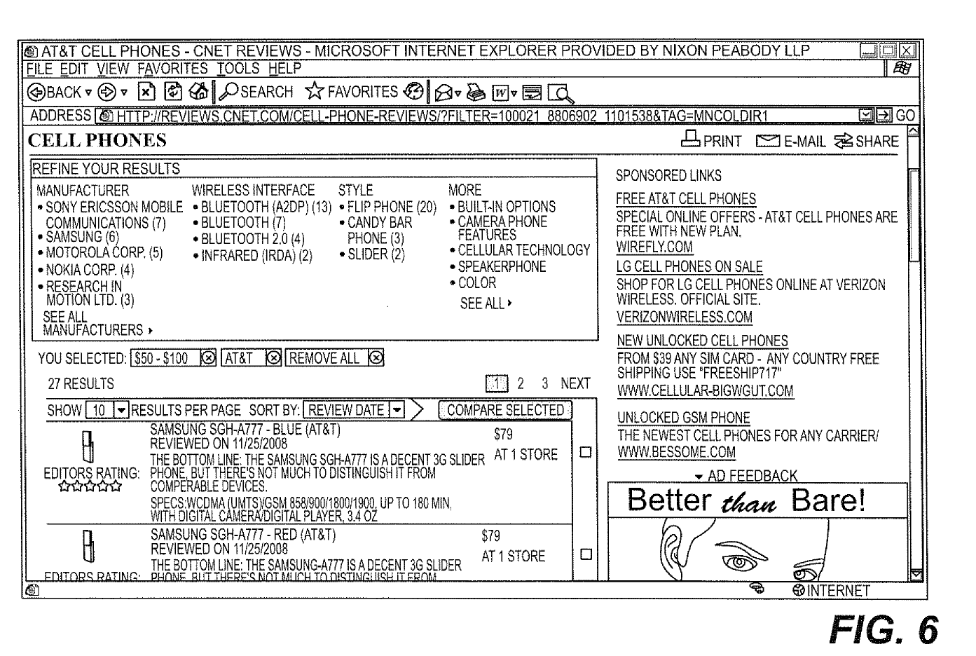

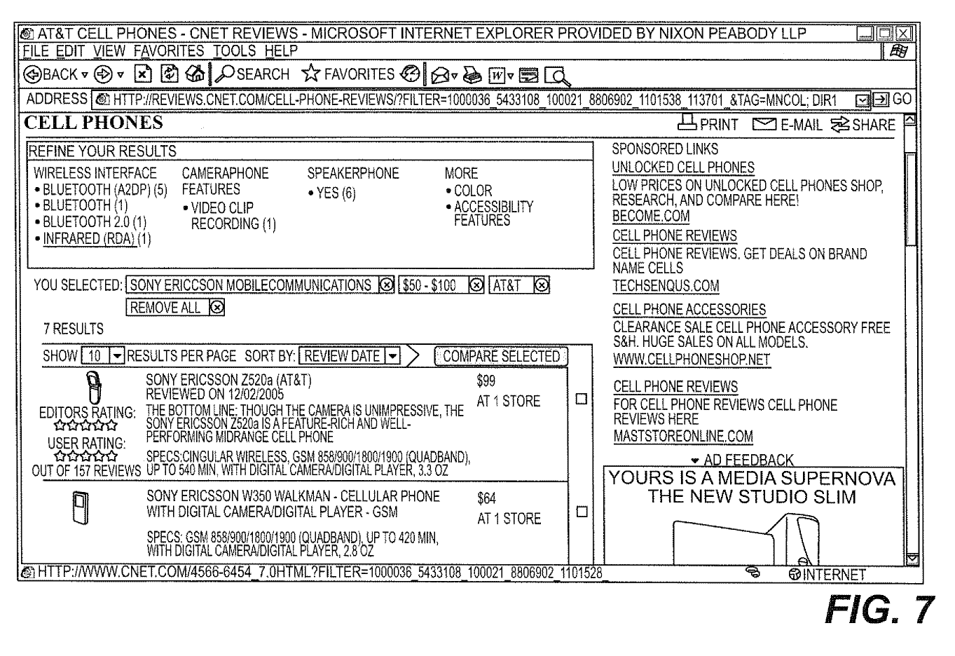

The information shown by the screenshots in FIGS. 3-7 is now explained in more detail, as an example of how the user selects filter parameters. FIG. 3 shows a home page of a shopping website, CNET.COM™, which offers access to a catalog of technology products, each of which has multiple attributes associated with it, each of which has a corresponding value. As can be seen in FIG. 3, some of the categories of technology which are in the catalog include “Appliances”, “Cell Phones”, “GPS”, “Laptops”, and many others. When a user clicks on one of these hyperlinks, he or she is brought, for example, to a page as shown in FIG. 4. which would result if the user had chosen the “Cell Phones” category from the homepage in FIG. 3. The catalog then allows the user to navigate from among the many cell phones in the catalog by progressively choosing filter parameters which narrow the selection of cell phones under consideration. Continuing our example, the user might choose that his or her preference was to see cell phones whose service provider was AT&T™. This would restrict consideration by the catalog to the 241 cell phones whose associated service provider is AT&T™. This leads to the resulting display of FIG. 5, which shows the first two phones in an extended list of phones whose service provider is AT&T™. At this point, the set of criteria displays further narrowing filter parameters for selection by the user, such as price, manufacturer, wireless interface, and others. It is to be noted, of course, that this filtration is progressive, i.e. additive. That is, once it has been selected that the service provider is AT&T™, the catalog is designed to reflect, as in FIG. 6, after the appropriate filter parameter selection, only those $50-$100 phones that are also designed to have AT&T™ as a service provider. Proceeding onwards, the user may select the additional filter given these two constraints that the manufacturer of the phone is Sony Ericsson Mobile™ communications, as in FIG. 7. Thus, by adding these progressive filters, the search set narrows from hundreds of potential cell phones to 241 AT&T™ cell phones to 27 AT&T™/$50-$100 cell phones to 7 AT&T™/$50-$100/Sony Ericsson Mobile™ cell phones.

As a system accepts filter input while users search the catalog, it is possible to monitor the set of filter parameters that users of a catalog system enter over a period of time. This data can be used to draw inferences about the behavior of the overall group of users who have contributed to a set of filter parameters. Alternatively, this data may be used for other applications, such as by using text or graphics to summarize or depict the data, so that users may draw their own conclusions about what the data represents. Furthermore, the data from monitoring the set of filter parameters may allow the system to adopt a more intelligent approach to the filter interface with the users, in that it may allow the catalog interface to be able to be more or less selective about which filters or how many filters should become displayed to the user for their potential selection at any given time.

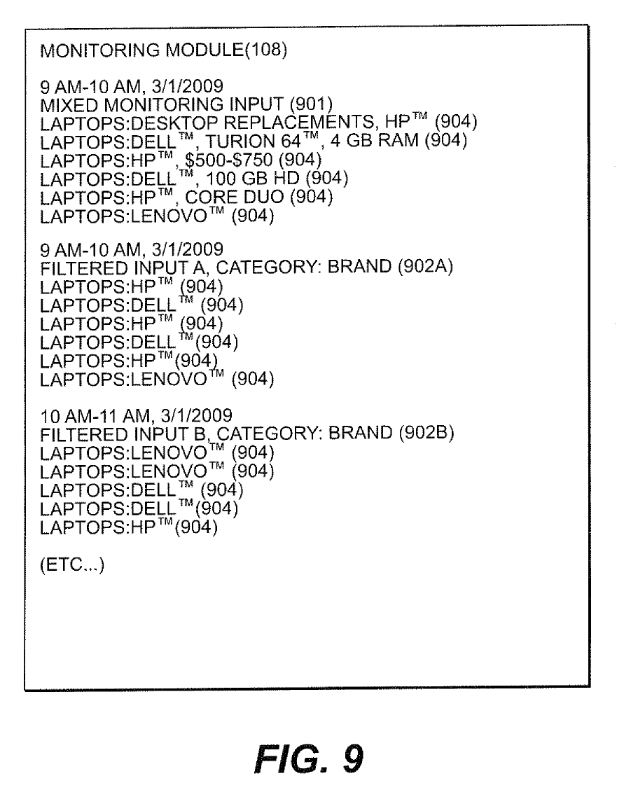

Some examples of this record of the filter selections are portrayed as being stored in one embodiment in FIG. 9 in the monitoring module 108. A mixed monitoring log 901 may consist of a flat file of entries indicating filters selected by users. The mixed monitoring log consists of a variety of filters, entered by users. Each filter is a sequence of selected filter parameters by individual users on one serach. The mixed monitoring log 901 may be stored in any usable format, but an exemplary format would be to use a text file, and to have one entry per line, with the filter parameters in the filter parameter set separated by commas. The mixed monitoring log 901 stores the complete filters. In the embodiments, at each stage of this narrowing process, the user is presumed to express a preference about what he or she is interested in. By adding a facility to the website which tracks the user's clicks by which he or she progressively selects the filter parameters, and thereby narrows the set of available products to produce a smaller set of products with characteristics that the user is looking for, a set of potentially useful data is generated. The user's actions may be captured, for example, if the catalog is accessed via a web page, where the web page consists of an HTML or XHTML document, by incorporating a facility which maintains a set of variables which change based on the user clicking on various filters. Technologies such as JavaScript scripts, Perl scripts, Java applets, JSP, ASP, as well as any other technology known in the art that allows the web page to register a click in a variable may be used by the various embodiments to maintain a tally of filter parameter selections within the taxonomy for further analysis and/or manipulation. In the preferred embodiment, they are stored as noted above in a monitoring log 901 as monitoring log entries 904, but any record of filter parameter selection which allows the analysis module to make inferences based on the filter parameters will be sufficient. The monitoring module 108 processes the information in a mixed monitoring log 901 to yield filtered input 902A and 902B, breaking the overall mixed monitoring log into groups based on time intervals, such as hours that the system is in operation. At this stage of the processing, the individual filter entries are manipulated so that only the entries for the individual categories are present. That is, in the case of 902A, an individual entry 904, Laptops:Dell™, Turion 64™, 4 GB RAM (904), becomes simply Laptops:Dell™.

An alternative embodiment further acquires additional information about the selections made of the various filters with the catalog system with respect to the hierarchy, storing, instead of a mere tally of selections, a tally of selections along with level information. For example, if the product were MP3 players, the embodiment would be capable of storing how many users selected Sony™ MP3 players as their first choice of filter parameter, as opposed to second, third, etc. When the information is processed by the user activity data output module 112, it may graph or otherwise the data based on this information. Tallying can be also done on the fly to analyze the filter selections from a monitoring log 901. It is to be noted that an actual mixed monitoring log will probably include different filters from multiple categories; FIG. 9 has been simplified for clarity's sake.

This aggregation of filter data is an ongoing process, with the embodiments creating a stream of data which is stored in the mixed monitoring log 901, either continuously or at discrete, hatched intervals. As the data aggregates into the mixed monitoring log, it will also generate sets of filtered input, such as 902A and 902B. These sets of filtered input may be generated such that they are generated for every attribute within the category being analyzed, or they may be generated for a select subset of the categories, or even only one.

Once the filtered input sets, 902A and 902B, have been generated, they can be tallied to generate tallies of filter selections over time intervals. These filter selections may be tracked by individual user selections, in that they are derived from progressive construction of the filter by the addition of filter parameters to the complete filters, and then added to the tallies of the filter parameters in the time intervals. The filter parameters may also be tracked by session, such that totals of the filter selections are generated which compound the totals of how many filter parameters corresponding with each value of each attribute over the course of one login session by a given user.

Once the filter parameters have been tallied, then the embodiments can begin to manipulate and process them so as to provide feedback to the user using the user activity data output module 112. To begin this process, the monitoring module 108 either transmits the data or allows access by the user activity data output module 112 so that it can provide representations of the data, as well as patterns in the data. These patterns may be both general patterns, as well as patterns that depend upon the specific nature of the attributes involved. They may be recognized by algorithms, heuristics, mathematical analysis, statistical analysis, and/or user inspection of the data. The goal of this manipulation of the data is to generate information by transforming the filter data to yield data that may consist of summary data, such as text, or alternative graphical depictions of the filter data analysis. This may be performed by the user interface module either on a video monitor, or alternatively it may be provided to the user on a printout.

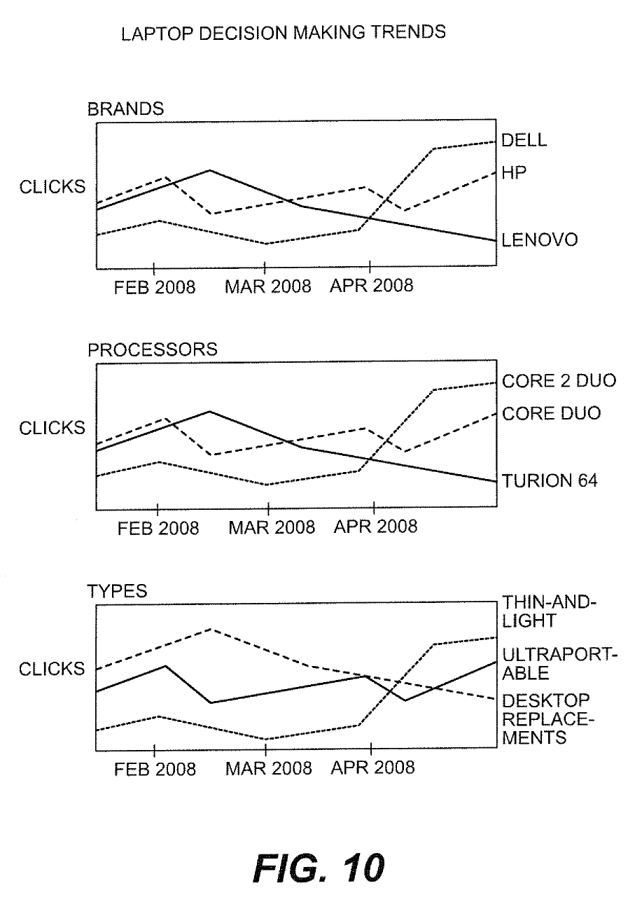

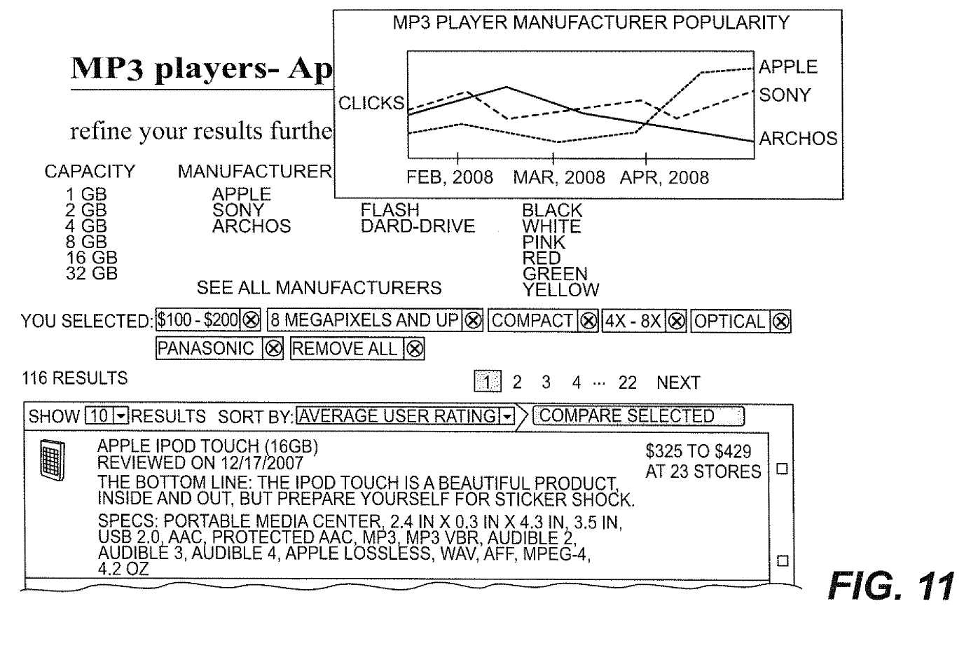

FIGS. 10-11 illustrate samples of graphical depictions of the filter data. In these figures, line graphs are used to illustrate the data, which consists of set of data points which is illustrative of tallies of filter parameters. However, any other form of graphical depiction which provides a representation of the data may be used to provide the user 110 with insight into the data. More specifically a line graph, a bar graph, or a pie chart may be used. The graphical depiction may illustrate information about the data how the frequency of certain values of the attributes changes over time, or what the total frequencies are over specific time intervals.

The user's 110 ability to manipulate and control the representations which the embodiments present may be facilitated by various features of the embodiments. For example, the user interface module 108 which presents the graphical depiction may include controls which change the time range depicted. Also, as in FIG. 11, the graphical depiction may be presented to the user in a pop-up window. Also as shown in FIG. 11, the graphical depiction may be presented to the user in a subpart of a window in which a list of products which results from determining the subset of products in the catalog which correspond with said filter parameters are displayed for the user. Alternatively stated, this embodiment concurrently displays both the list of products which naturally results from the user's selection of filter parameters through the user's use of the catalog, along with the graphical depiction referred to above which reflects some aspect of overall filter parameter use.

The embodiments may also allow flexible control over the graphical display. such that the user activity data output module possesses control which allow the user to selectively exclude and include one or more user-determined values of said categories and/or attributes from the graphical depiction. This can be done by simply processing through the data, using a Boolean test to filter out the extraneous data, and then graphing the remaining data.

Another potential feature of the embodiments is that the graphical depiction may include hyperlinks to filter parameters with categories or attribute values depicted in the graphical depiction which can be used to search the catalog. That is, if a graphical depiction includes lists of specific attribute values, such as “Dell™”, “Hp™”, and “Lenovo™” for the Brand attribute as in FIG. 10, a search page could be generated of the form of FIG. 11 which reflects a selection of one of the brands, as if it were an ordinary filter parameter selection in the ordinary course of operating the catalog. The attributes used to categorize the products or items in the catalog may be of any type that is appropriate for a given set of products. However, if the products are pieces of technology, the attributes may include one or more of brands, prices, and technologies.

Of course, one of the most valuable capabilities and features of the embodiments is its ability to analyze the filter parameter information. One way in which this can be done is to have the filter parameter selections relevant to a given attribute received over a given time interval be decomposed to yield a set of proportions for each value of the attribute, determined over the set of possible values, received over said time interval. This capability essentially describes the analysis which occurs when the embodiments construct a pie chart of activity, in that, for example, the category might be televisions, and the embodiment would take the information about which brands of television had been selected for use as filter parameters, and for example might find that there were, over a 3-month period, 12% Sony™, 35% Panasonic™, 13% Sharp™, and 40% Samsung™ brand selections associated with televisions. This of course, could be portrayed as a pie chart or analyzed and manipulated in other ways, for example by comparing Sony™'s percentage in this category to another category, like laptops. Of course, these proportions may be expressed as a percent, a decimal fraction, a standard fraction (for example, 234/452 selections) or any other means of expressing a proportion. It may also be desirable to change the time interval which the fractions reflect, and by obtaining a sequence of data points with proportions of this type, it is possible to observe how input has been changing in the system over time. It is noted that the proportion, rather than the absolute number, of filter parameter selections, can vary widely on a daily basis (an embodiment might be more widely used at 2 PM than 2 AM) but we have found that the proportions of various values relative to the total usage is a more consistent barometer of usage patterns because it reflects popularity of choices.

An addition way in which the embodiments may obtain useful information from these proportions is to allow the user to request and receive mathematical and/or statistical analyses of information about said proportions. That is, the user may obtain information through any technique which uses any algorithm, formula, heuristic, or other technique that takes the raw data and draws the information in the data together to summarize the data or draw conclusions from it. For example, as noted previously, the proportions may be graphed versus time to show how different specific attribute values have different frequencies. Some basic mathematical techniques that the embodiments may employ may be derivatives to establish rates of change for the data (coupled with curve fitting techniques), integrals to establish overall total popularity over a period of time (coupled with approximation techniques), as well as identification of maximums, minimums, and averages.

The embodiments may also restrict the group the data of users whose actions are considered for the analysis, by factors such as, but not limited to, geographic location, IP address, demographics such as age, gender, groupings (such as Macintosh™ users, gamers, business professionals, IT professionals, etc.). The embodiments thus may be designed to gather user profile data through a user profile data gathering module, wherein the user profile data gathering module gathers personal information about users, as just outlined, and stores data including a link between said personal information with said user activity data and the user activity data output reflects the personal information of at least one user store in the user profile data gathering module. Optionally, an embodiment may include a facility to gather such information from the user to aid in the later analysis of the user's filter selections. Such a facility to gather information about the user may be integrated into the web page as a form, or it may take the form of a pop-up box. Alternatively, the embodiment may automatically gather information about the user by associating his or her IP address with information gained by associating that IP address with information in a database. This data may be further used by the embodiments such that the embodiments may be designed to recommend that a user buy a product from a given category when user profile data and/or user activity data fall within predefined or user-configurable parameters, depending on how a particular embodiment is designed. Alternatively, the embodiments may make a similar recommendation, but it may be that the user not buy products from a given category. The way in which these recommendations are derived may vary, but one simple way in which they may be derived is to make recommendations for the most popular (or alternatively, top 3, top 5, etc.) choices in terms of filter parameter selection proportion, and not to recommend the least popular (least 3 unpopular, least 5 unpopular, etc.)

It is to be noted that the filter parameters are tracked on the basis of individual user selections. That is, each time a filter parameter is selected, regardless of whether how many filter parameters are involved in the whole filter being built, it counts towards tallies of the various values of the attributes. An alternative approach which may be used is that only filter parameters up to a certain depth are to be counted . . . for example . . . only the first three levels of filter parameters are counted, and the others are deemed to be so unimportant to the user's search that they should not be count

Thus, overall, one embodiment of the invention may be understood as a method 800 involving steps to be performing on a computing system consisting of multiple modules designed to perform computing functions which transform data monitoring results, wherein at least part of the computing system's functionality is performed by hardware, comprising. Using a computer processor, operating a database module configured to store an electronic catalog of products, wherein the catalog comprises a taxonomy of products categories and products thin the categories, the catalog further comprising attributes which describe products in a category and at least one value for said attributes 801, using a computer processor, operating a user interface module configured to accept filter parameters, where each filter parameter specifies at least one of a product category and an attribute, in response to a selection by at least one user 802, using a computer processor, operating a query module configured to receive the filter parameters, query the catalog, and present a subset of products in the catalog corresponding to the filter parameters to said user interface module for display to said at least one user 803, using a computer processor, operating a monitoring module configured to track the received filter parameters and generates a set of user activity data that indicates the filter parameters selected by said at least one user 804, and using a computer processor, operating a user activity data output module configured to, in response to a user selection of at least one filter parameter, provide user activity data output related to said user activity data related to previous users selecting filter parameters that are the same or similar to the user's selection 805.

Thus, the embodiments allow collection of information about the users' filter preferences which can reflect not only long-term trends in filter selection, but can also be used to allow the user into analyses of that information as well as various approaches to mining the information and relating it to other real-world factors. In addition to merely allowing the user access to this information, which is novel in itself, the combination of access to this information with the types of visualizations and manipulations outlined here provide a powerful and sophisticated e-commerce tool which brings unexpected advantages to the operation of a catalog by providing visual feedback about an unusual source of data and providing the opportunity to manipulate it to obtain insight into an aspect of user behavior that has not been exploited in this way before, with the particular advantage that it offers specific ongoing information about a facet of user preferences that the user could not otherwise access.

It should be noted that the filter parameter information system 100 is illustrated and discussed herein as having various modules which perform particular functions and interact with one another. It should be understood that these modules are merely segregated based on their function for the sake of description and do not necessarily represent discrete hardware or software code which is stored on a computer-readable medium for execution on appropriate computing hardware such as a processor. In this regard, these modules, units and other components may be hardware and/or software stored on a computer-readable medium for execution on appropriate computing hardware such as a processor may be thus implemented to substantially perform their particular functions explained herein. The various functions of the different modules and units can be combined or segregated as hardware and/or software stored on a computer-readable medium as above as modules in any mranner, and can be used separately or in combination.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

What is claimed is:

1. A computer system designed to provide filter parameter trend information, comprising:
a database module configured to store an electronic catalog of products, wherein the catalog comprises a taxonomy of products categories and products within the categories, the catalog further comprising attributes which describe products in a category and at least one value for said attributes;
a user interface module configured to accept filter parameters, where each filter parameter specifies at least one of a product category and an attribute, in response to a selection by at least one user;
a query module configured to receive the filter parameters, query the catalog, and present a subset of products in the catalog corresponding to the filter parameters to said user interface module for display to said at least one user;
a monitoring module configured to track the received filter parameters and generates a set of user activity data that indicates the filter parameters selected by said at least one user; and
a user activity data output module configured to, in response to a user selection of at least one filter parameter, provide user activity data output related to said user activity data related to previous users selecting filter parameters that are the same or similar to the user's selection.

2. The system of claim 1, wherein said user activity data output consists of text.

3. The system of claim 1, wherein said user activity data output is a graphical depiction of the user activity data.

4. The system of claim 3, wherein said user activity data output is displayed to the user on a video monitor.

5. The system of claim 3, wherein said graphical depiction is one of: a line graph, a bar graph, or a pie chart.

6. The system of claim 3, wherein said graphical depiction includes controls which change the time range depicted.

7. The system of claim 3, wherein said graphical depiction is presented to the user in a pop-up window.

8. The system of claim 3, wherein said graphical depiction is presented to the user in a subpart of a window in which a list of products which results from determining the subset of products in the catalog which correspond with said filter parameters are displayed for the user.

9. The system of claim 3, wherein said user activity data output module possesses controls which allow the user to selectively exclude and include one or more user-determined values of said categories and/or said attributes from the graphical depiction.

10. The system of claim 3, wherein said graphical depiction includes hyperlinks to filter parameters with categories or attribute values depicted in the graphical depiction which can be used to search the catalog.

11. The system of claim 1, wherein said attributes include one or more of: brands, prices and technologies.

12. The system of claim 1, wherein the filter parameter selections relevant to a given attribute received over a given time interval is decomposed to yield a set of proportions for each value of the attribute, determined over the set of possible values, received over said time interval.

13. The system of claim 12, wherein each of said proportions is expressed as a percent.

14. The system of claim 12, wherein said user interface module allows the user to request and receive mathematical and/or statistical analyses of information about said proportions.

15. The system of claim 14, wherein said mathematical information comprises information gained based on derivatives of said proportions versus time.

16. The system of claim 14, wherein said mathematical information comprises information gained based on integrals of said proportions versus time.

17. The system of claim 14, wherein said statistical information comprises a maximum user activity data frequency value.

18. The system of claim 14, wherein said statistical information comprises a minimum user activity data frequency value.

19. The system of claim 1, wherein the system includes an Internet interface module that is configured to allow users to interface with the user interface module via IP. wherein the user activity data analysis module records IP information and groups the user activity into sets by geographic region.

20. The system of claim 1, further comprising a user profile data gathering module, configured to gather personal information about users, and stores data including a link between said personal information with said user activity data and the user activity data output reflects the personal information of at least one user stored in the user profile data gathering module.

21. The svstem of claim 20, further comprising a recommendation module configured to recommend that a user buy a product from a given category when said user profile data and/or user activity data fall within predefined or user-configurable parameters.

22. The system of claim 20, further comprising a recommendation module configured to recommend that a user not buy a product from a given category when said user profile data and/or user activity data fall within predefined or user-configurable parameters.

23. The system of claim 1, wherein the monitoring module tracks filter parameters on the basis of individual user selections.

24. The system of claim 1, wherein the monitoring module tracks filter parameters.

25. The system of claim 1, wherein said products are digital content.

26. The system of claim 25, wherein said digital content products consist of one or more of digital text, audio, MIDI data, recorded audiobooks, digital music, bitmapped and/or vector graphics, digital photographs, video, movies, TV episodes, digital documents, animations, software, web content, multimedia, or encoded or archived data.

27. The system of claim 26, wherein the catalog contains items of digital content and items of merchandise, and some items of digital content are associated with the items of merchandise.

28. A method involving steps to be performing on a computing system consisting of multiple modules designed to perform computing functions which transform data monitoring results, wherein at least part of the computing system's functionality is performed by hardware, comprising:
using a computer processor, operating a database module configured to store an electronic catalog of products, wherein the catalog comprises a taxonomy of products categories and products within the categories, the catalog further comprising attributes which describe products in a category and at least one value for said attributes;
using a computer processor, operating a user interface module configured to accept filter parameters, where each filter parameter specifies at least one of a product category and an attribute, in response to a selection by at least one user;
using a computer processor, operating a query module configured to receive the filter parameters, query the catalog, and present a subset of products in the catalog corresponding to the filter parameters to said user interface module for display to said at least one user;
using a computer processor, operating a monitoring module configured to track the received filter parameters and generates a set of user activity data that indicates the filter parameters selected by said at least one user; and
using a computer processor, operating a user activity data output module configured to, in response to a user selection of at least one filter parameter, provide user activity data output related to said user activity data related to previous users selecting filter parameters that are the same or similar to the user's selection.

29. The method of claim 28, wherein said user activity data output consists of text.

30. The method of claim 28, wherein said user activity data output is a graphical depiction of the user activity data.

31. The method of claim 30, wherein said user activity data output is displayed to the user on a video monitor.

32. The method of claim 30, wherein said graphical depiction is one of: a line graph, a bar graph, or a pie chart.

33. The method of claim 30, wherein said graphical depiction includes controls which change the time range depicted.

34. The method of claim 30, wherein said graphical depiction is presented to the user in a pop-up window.

35. The method of claim 30, wherein said graphical depiction is presented to the user in a subpart of a window in which a list of products which results from determining the subset of products in the catalog which correspond with said filter parameters are displayed for the user.

36. The method of claim 30, wherein said user activity data output module possesses controls which allow the user to selectively exclude and include one or more user-determined values of said categories and/or said attributes from the graphical depiction.

37. The method of claim 30, wherein said graphical depiction includes hyperlinks to filter parameters with categories or attribute values depicted in the graphical depiction which can be used to search the catalog.

38. The method of claim 28, wherein said attributes include one or more of: brands, prices and technologies.

39. The method of claim 28, wherein the filter parameter selections relevant to a given attribute received over a given time interval is decomposed to yield a set of proportions for each value of the attribute, determined over the set of possible values. received over said time interval.

40. The method of claim 39, wherein each of said proportions is expressed as a percent.

41. The method of claim 39, wherein said user interface module allows the user to request and receive mathematical and/or statistical analyses of information about said proportions.

42. The method of claim 41, wherein said mathematical information comprises information gained based on derivatives of said proportions versus time.

43. The method of claim 41, wherein said mathematical information comprises information gained based on integrals of said proportions versus time.

44. The method of claim 41, wherein said statistical information comprises a maximum user activity data frequency value.

45. The method of claim 41, wherein said statistical information comprises a minimum user activity data frequency value.

46. The method of claim 28, wherein the method includes operating an Internet interface module that is configured to allow users to interface with the user interface module via IP, wherein the user activity data analysis module records IP information and groups the user activity into sets by geographic region.

47. The method of claim 28, further comprising operating a user profile data gathering module, configured to gather personal information about users, and stores data including a link between said personal information with said user activity data and the user activity data output reflects the personal information of at least one user stored in the user profile data gathering module.

48. The method of claim 47, further comprising operating a recommendation module configured to recommend that a user buy a product from a given category when said user profile data and/or user activity data fall within predefined or user-configurable parameters.

49. The method of claim 47, further comprising operating a recommendation module configured to recommend that a user not buy a product from a given category when said user profile data and/or user activity data fall within redefined or user-configurable parameters.

50. The method of claim 28, wherein the monitoring module tracks filter parameters on the basis of individual user selections.

51. The method of claim 28, wherein the monitoring module tracks filter parameters.

52. The method of claim 28, wherein said products are digital content.

53. The method of claim 52, wherein said digital content products consist of one or more of digital text, audio, MIDI data, recorded audiobooks, digital music, bitmapped and/or vector graphics, digital photographs, video, movies, TV episodes, digital documents, animations, software, web content, multimedia, or encoded or archived data.

54. The method of claim 53, wherein the catalog contains items of digital content and items of merchandise, and some items of digital content are associated with the items of merchandise.

55. An apparatus involving means for performing steps to be performed on a computing system consisting of multiple modules designed to perform computing functions, wherein at least part of the computing system's functionality is performed by hardware for facilitating browsing of catalog information, the apparatus comprising:
means for, using a computer processor, operating a database module configured to store an electronic catalog of products, wherein the catalog comprises a taxonomy of products categories and products within the categories, the catalog further comprising attributes which describe products in a category and at least one value for said attributes;
means for, using a computer processor, operating a user interface module configured to accept filter parameters, where each filter parameter specifies at least one of a product category and an attribute, in response to a selection by at least one user;
means for, using a computer processor, operating a query module configured to receive the filter parameters, query the catalog, and present a subset of products in the catalog corresponding to the filter parameters to said user interface module for display to said at least one user;
means for, using a computer processor, operating a monitoring module configured to track the received filter parameters and generates a set of user activity data that indicates the filter parameters selected by said at least one user;
means for, using a computer processor, operating a user activity data output module configured to, in response to a user selection of at least one filter parameter, provide user activity data output related to said user activity data related to previous users selecting filter parameters that are the same or similar to the user's selection.

56. The apparatus of claim 55, wherein said user activity data output consists of text.

57. The apparatus of claim 55, wherein said user activity data output is a graphical depiction of the user activity data.

58. The apparatus of claim 57, wherein said user activity data output is displayed to the user on a video monitor.

59. The apparatus of claim 57, wherein said graphical depiction is one of: a line graph, a bar graph, or a pie chart.

60. The apparatus of claim 57, wherein said graphical depiction includes controls which change the time range depicted.

61. The apparatus of claim 57, wherein said graphical depiction is presented to the user in a pop-up window.

62. The apparatus of claim 57, wherein said graphical depiction is presented to the user in a subpart of a window in which a list of products which results from determining the subset of products in the catalog which correspond with said filter parameters are displayed for the user.

63. The apparatus of claim 57, wherein said user activity data output module possesses controls which allow the user to selectively exclude and include one or more user-determined values of said categories and/or said attributes from the graphical depiction.

64. The apparatus of claim 57, wherein said graphical depiction includes hyperlinks to filter parameters with categories or attribute values depicted in the graphical depiction which can be used to search the catalog.

65. The apparatus of claim 55, wherein said attributes include one or more of: brands, prices and technologies.

66. The apparatus of claim 55, wherein the filter parameter selections relevant to a given attribute received over a given time interval is decomposed to yield a set of proportions for each value of the attribute, determined over the set of possible values, received over said time interval.

67. The apparatus of claim 66, wherein each of said proportions is expressed as a percent.

68. The apparatus of claim 66, wherein said user interface module allows the user to request and receive mathematical and/or statistical analyses of information about said proportions.

69. The apparatus of claim 68, wherein said mathematical information comprises information gained based on derivatives of said proportions versus time.

70. The apparatus of claim 68, wherein said mathematical information comprises information gained based on integrals of said proportions versus time.

71. The apparatus of claim 68, wherein said statistical information comprises a maximum user activity data frequency value.

72. The apparatus of claim 68, wherein said statistical information comprises a minimum user activity data frequency value.

73. The apparatus of claim 55, wherein the apparatus includes an Internet interface module that is configured to allow users to interface with the user interface module via IP, wherein the user activity data analysis module records IP information and groups the user activity into sets by geographic region.

74. The apparatus of claim 55, further comprising means for operating a user profile data gathering module, configured to gather personal information about users, and stores data including a link between said personal information with said user activity data and the user activity data output reflects the personal information of at least one user stored in the user profile data gathering module.

75. The apparatus of claim 74, further comprising means for operating a recommendation module configured to recommend that a user buy a product from a given category when said user profile data and/or user activity data fall within predefined or user-configurable parameters.

76. The apparatus of claim 74, further comprising means for operating a recommendation module configured to recommend that a user not buy a product from a given category when said user profile data and/or user activity data fall within predefined or user-configurable parameters.

77. The apparatus of claim 55, wherein the monitoring module tracks filter parameters on the basis of individual user selections.

78. The apparatus of claim 55, wherein the monitoring module tracks filter parameters.

79. The apparatus of claim 55, wherein said products are digital content.

80. The apparatus of claim 79, wherein said digital content products consist of one or more of digital text, audio, MIDI data, recorded audiobooks, digital music, bitmapped and/or vector graphics, digital photographs, video, movies, TV episodes, digital documents, animations, software, web content, multimedia, or encoded or archived data.

81. The apparatus of claim 80, wherein the catalog contains items of digital content and items of merchandise, and some items of digital content are associated with the items of merchandise.

82. Computer readable media, having instructions stored thereon, wherein the instructions, when executed by a computer processor, perform steps to be performed on a computing system consisting of multiple modules designed to perform computing functions, wherein at least part of the computing system's functionality is performed by hardware for facilitating browsing of catalog information, the instructions comprising:
instructions for operating a database module configured to store an electronic catalog of products, wherein the catalog comprises a taxonomy of products categories and products within the categories, the catalog further comprising attributes which describe products in a category and at least one value for said attributes;
instructions for operating a user interface module configured to accept filter parameters, where each filter parameter specifies at least one of a product category and an attribute, in response to a selection by at least one user;
instructions for operating a query module configured to receive the filter parameters, query the catalog, and present a subset of products in the catalog corresponding to the filter parameters to said user interface module for display to said at least one user;
instructions for operating a monitoring module configured to track the received filter parameters and generates a set of user activity data that indicates the filter parameters selected by said at least one user; and
instructions for operating a user activity data output module configured to, in response to a user selection of at least one filter parameter, provide user activity data output related to said user activity data related to previous users selecting filter parameters that are the same or similar to the user's selection.

83. The computer readable media of claim 82, wherein said user activity data output consists of text.

84. The computer readable media of claim 82, wherein said user activity data output is a graphical depiction of the user activity data.

85. The computer readable media of claim 84, wherein said user activity data output is displayed to the user on a video monitor

86. The computer readable media of claim 84, wherein said graphical depiction is one of: a line graph, a bar graph, or a pie chart.

87. The computer readable media of claim 84, wherein said graphical depiction includes controls which change the time range depicted.

88. The computer readable media of claim 84, wherein said graphical depiction is presented to the user in a pop-up window.

89. The computer readable media of claim 84, wherein said graphical depiction is presented to the user in a subpart of a window in which a list of products which results from determining the subset of products in the catalog which correspond with said filter parameters are displayed for the user.

90. The computer readable media of claim 84, wherein said user activity data output module possesses controls which allow the user to selectively exclude and include one or more user-determined values of said categories and/or said attributes from the graphical depiction.

91. The computer readable media of claim 84, wherein said graphical depiction includes hyperlinks to filter parameters with categories or attribute values depicted in the graphical depiction which can be used to search the catalog.

92. The computer readable media of claim 82, wherein said attributes include one or more of: brands, prices and technologies.

93. The computer readable media of claim 82, wherein the filter parameter selections relevant to a given attribute received over a given time interval is decomposed to yield a set of proportions for each value of the attribute, determined over the set of possible values, received over said time interval.

94. The computer readable media of claim 83, wherein each of said proportions is expressed as a percent.

95. The computer readable media of claim 83, wherein said user interface module allows the user to request and receive mathematical and/or statistical analyses of information about said proportions.

96. The computer readable media of claim 95, wherein said mathematical information comprises information gained based on derivatives of said proportions versus time.

97. The computer readable media of claim 95, wherein said mathematical information comprises information gained based on integrals of said proportions versus time.

98. The computer readable media of claim 95, wherein said statistical information comprises a maximum user activity data frequency value.

99. The computer readable media of claim 95, wherein said statistical information comprises a minimum user activity data frequency value.

100. The computer readable media of claim 82, wherein the computer readable media includes instructions for operating an Internet interface module that is configured to allow users to interface with the user interface module via IP, wherein the user activity data analysis module records IP information and groups the user activity into sets by geographic region.

101. The computer readable media of claim 82, further comprising instructions for operating a user profile data gathering module, configured to gather personal information about users, and stores data including a link between said personal information with said user activity data and the user activity data output reflects the personal information of at least one user stored in the user profile data gathering module.

102. The computer readable media of claim 101, further comprising instructions for operating a recommendation module configured to recommend that a user buy a product from a given category when said user profile data and/or user activity data fall within predefined or user-configurable parameters.

103. The computer readable media of claim 101, further comprising instructions for operating a recommendation module configured to recommend that a user not buy a product from a given category when said user profile data and/or user activity data fall within predefined or user-configurable parameters.

104. The computer readable media of claim 82, wherein the monitoring module tracks filter parameters on the basis of individual user selections.

105. The computer readable media of claim 82, wherein the monitoring module tracks filter parameters.

106. The computer readable media of claim 82, wherein said products are digital content.

107. The computer readable media of claim 106, wherein said digital content products consist of one or more of digital text, audio, MIDI data, recorded audiobooks, digital music, bitmapped and/or vector graphics, digital photographs, video, movies, TV episodes, digital documents, animations, software, web content, multimedia, or encoded or archived data.

108. The computer readable media of claim 107, wherein the catalog contains items of digital content and items of merchandise, and some items of digital content are associated with the items of merchandise.
